(19) United States
(12) Patent Application Publication
(10) Pub. No.: US 2009/0042522 A1
(43) Pub. Date: Feb. 12, 2009

(54) TRANSMITTER AND COMMUNICATION DEVICE USING THE SAME

(75) Inventors: Yukio Sakai, Hyogo (JP); Hiroki Iwamiya, Osaka (JP); Yuji Osumi, Nara (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/816,932

(22) PCT Filed: Dec. 21, 2006
(86) PCT No.: PCT/JP2006/325466

§ 371 Date: Aug. 23, 2007

(30) Foreign Application Priority Data
Dec. 28, 2005 (JP) 2005-377938

(51) Int. Cl. H04B 1/04

(52) U.S. Cl. 455/129

(57) ABSTRACT

A transmitter includes a board, an electronic circuit provided on the board for outputting a transmission signal, an amplifier provided on the board for amplifying the transmission signal, an antenna terminal provided on the board and arranged to be connected to an antenna, and a transmission path arranged along a border of the board. The transmission path is connected to an output port of the amplifier and the antenna terminal. The transmission path supplies the amplified transmission signal to the antenna terminal. This transmitter prevents the transmitting signal from entering into other circuits, and thus, has preferable transmission characteristics.

### TECHNICAL FIELD

The present invention relates to a transmitter used for wireless communications, and to a communication device including the transmitter.

### BACKGROUND OF THE INVENTION

FIG. 9 is a top view of conventional transmitter 1. Transmitter 1 includes semiconductor circuit 3 arranged on board 2, amplifier 4 connected to an output port of semiconductor circuit 3, transmission line 5 connected to amplifier 4, and antenna terminal 6 connected to transmission line 5. Transmission line 5 is arranged close to the center of an upper surface of board 2.

Transmission line 5 is arranged close to the center of board 2 of transmitter 1, hence causing a large transmitting signal amplified by amplifier 4 to pass near the center of board 2. This transmitting signal may accordingly enter into other circuits, such as semiconductor device 3, thus degrading transmission characteristic of transmitter 1.

### SUMMARY OF THE INVENTION

A transmitter includes a board, an electronic circuit provided on the board for outputting a transmission signal, an amplifier provided on the board for amplifying the transmission signal, an antenna terminal provided on the board and arranged to be connected to an antenna, and a transmission path arranged along a border of the board. The transmission path is connected to an output port of the amplifier and the antenna terminal. The transmission path supplies the amplified transmission signal to the antenna terminal.

This transmitter prevents the transmitting signal from entering into other circuits, and thus, has preferable transmission characteristics.

### BRIEF DESCRIPTION OF DRAWINGS

FIG. 1A is a top view of a transmitter in accordance with Exemplary Embodiment 1 of the present invention.

FIG. 1B is a top view of another transmitter in accordance with Embodiment 1.

FIG. 1C is a top view of a further transmitter in accordance with Embodiment 1.

FIG. 1D is a top view of a further transmitter in accordance with Embodiment 1.

FIG. 1E is a schematic view of a communication device in accordance with Embodiment 1.

FIG. 2 is a top view of a transmitter in accordance with Exemplary Embodiment 2 of the invention.

FIG. 3 is a top view of another transmitter in accordance with Embodiment 2.

FIG. 4 is a top view of a further transmitter in accordance with Embodiment 2.

FIG. 5 is a top view of a further transmitter in accordance with Embodiment 2.

FIG. 6 is a side sectional view of a further transmitter in accordance with Embodiment 2.

FIG. 7 is a schematic view of a communication device in accordance with Embodiment 2.

FIG. 8 is a schematic view of another communication device in accordance with Embodiment 2.

FIG. 9 is a top view of a conventional transmitter.

### REFERENCE NUMERALS

8 Board
8A Upper Surface of Board (First Surface of Board)
8B Lower Surface of Board (Second Surface of Board)
8C Border of Board
9 Electronic Circuit
11 Amplifier
12 Transmission Line
13 Antenna Terminal
15 Oscillator
32 Connection Terminal
1008A Controller
1012 Transmission Path
2001B Receiver
2012 Transmission Path

### DETAILED DESCRIPTION OF THE PREFERRED EMBODIMENTS

### Exemplary Embodiment 1

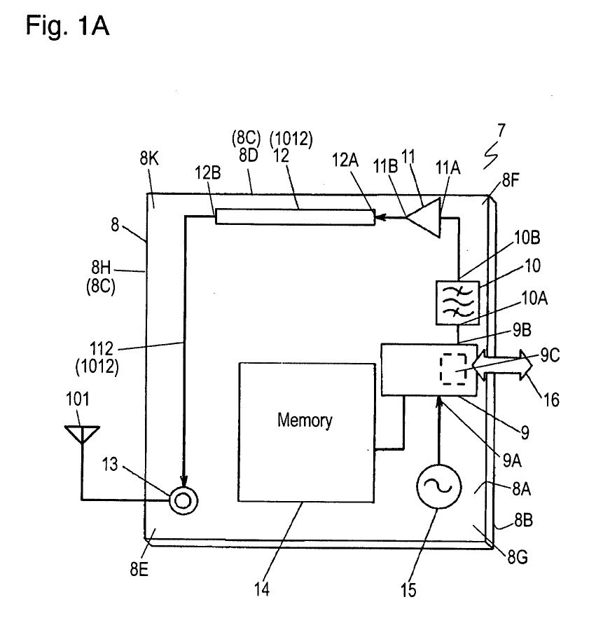

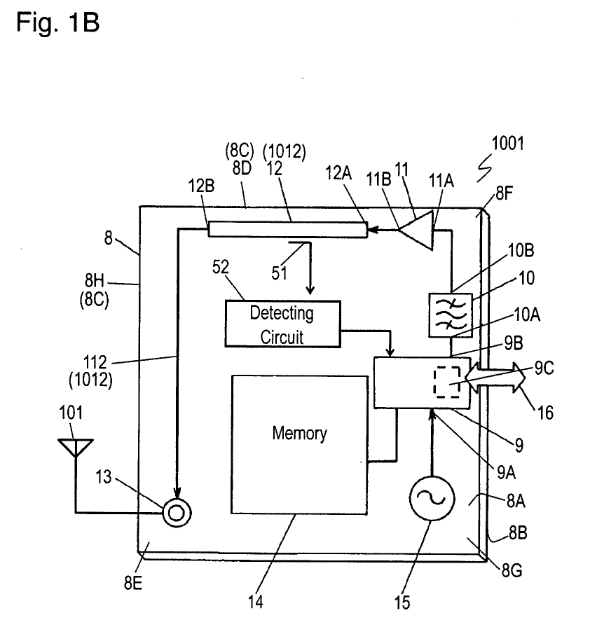

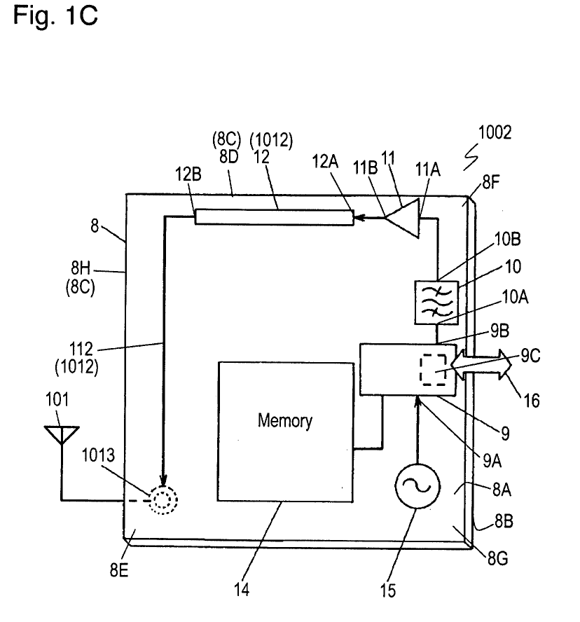

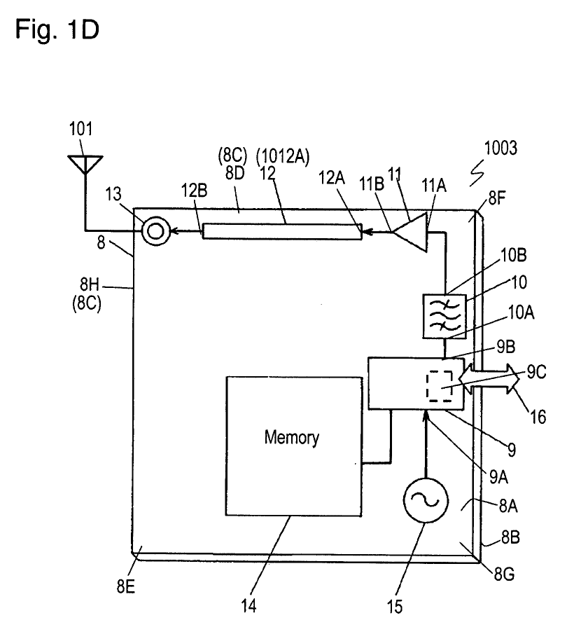

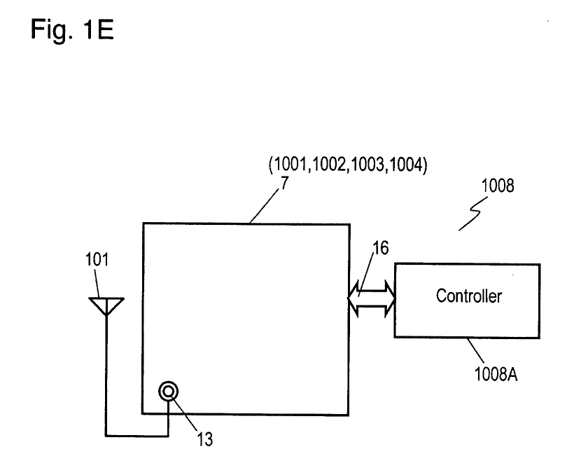

FIG. 1A is a top view of transmitter 7 according to Exemplary Embodiment 1 of the present invention. Transmitter 7 is, for example, a chip-type transmitter, and is connected to a communication device, such as a personal computer and mobile phone for wireless communication, such as a local area network (LAN). Board 8 has upper surface 8A and lower surface 8B opposite to upper surface 8A, and has four corners 8E, 8F, 8G, and 8K. Input port 10A of filter 10 is connected by high-frequency AC coupling to output port 9B of electronic circuit 9 including a semiconductor provided on upper surface 8A of board 8. Input port 11A of amplifier 11 is connected to output port 10B of filter 10 by high-frequency AC coupling. Input port 12A of transmission line 12 is connected to output port 11B of amplifier 11 by high-frequency AC coupling. Antenna terminal 13 is connected to output port 12B of transmission line 12 via transmission line 112.

Board 8 is a rectangular multilayer board made of resin, such as glass epoxy. Board 8 has a thickness not larger than 0.5 mm so as to reduce the thickness of transmitter 7.

Electronic circuit 9 is an integrated circuit (IC) formed by a CMOS process, and generates a transmitting signal. Memory 14, oscillator 15, and bus 16 are connected to electronic circuit 9. Electronic circuit 9 includes transmitting circuit 9C for generating a transmission signal. Electronic circuit 9 may include other circuits, such as a receiving circuit, a signal processing circuit, a media access control (MAC) circuit for wireless LAN, an SD input/output (SDIO) circuit, a serial parallel interface (SPI) circuit, a universal asynchronous receiver/transmitter (UART) circuit, a 12C circuit, a general-purpose input/output (GPIO) circuit, a microcomputer, and a joint test action group (JTAG) interface circuit.

Memory 14 is a non-volatile memory, such as RAM and ROM, and is connected to electronic circuit 9.

Oscillator 15 is connected to input port 9A of electronic circuit 9, and is used as a reference oscillator for transmitter 7. Oscillator 15 includes a crystal, and supplies signals having oscillation frequencies not higher than 100 MHz, for example, 40 MHz, to electronic circuit 9.

Filter 10 is made of dielectric material, and passes signals within in a predetermined frequency band. Filter 10 and electronic circuit 9 are connected by balanced connection so as to remove common-mode noise output from electronic circuit 9.

Amplifier 11 amplifies an input transmitting signal to a predetermined level which can be transmitted from antenna terminal 13. Amplifier 11 is an integrated circuit (IC) formed by a compound semiconductor process, and is a two-stage device having a control voltage terminal for controlling saturated drain current.

Transmission line 12 supplies a transmitting signal amplified by amplifier 11 to antenna terminal 13. Transmission line 12 is a micro-strip line which is a straight line with a width of about 70 micrometers and a characteristic impedance not smaller than 50Ω. Since transmission line 12 has a shape formed along side 8D of rectangular board 8 and is arranged along side 8D. This arrangement allows the transmission signal to pass along border 8C of board 8. This prevents the transmission signal from entering into other circuits, such as electronic circuit 9, memory 14, and oscillator 15, accordingly improving transmission characteristics of transmitter 7. In particular, if transmitter 7 is a chip-type small transmitter, transmission line 12 may be a micro-strip line or strip-line which is not straight.

Transmission line 112 has a shape formed along side 8H which is a part of border 8C of rectangular board 8, and is arranged along side 8H. In other words, transmission path 1012 including transmission lines 12 and 112 has a shape formed along border 8C of board 8, and is arranged along border 8C.

Antenna terminal 13 is implemented by a connector, a through hole provided in board 8, or a conductor, such as solder. Antenna 101 is connected to antenna terminal 13. The transmission signal output from transmission line 12 is supplied from antenna terminal 13 to antenna 101. Antenna terminal 13 and amplifier 11 may be preferably placed at positions 8E and 8F, respectively, which are corners of rectangular board 8 diagonal to each other. This arrangement prevents the transmission signal amplified by amplifier 11 from being coupled to antennal terminal 13.

Amplifier 11, transmission line 12, and antenna terminal 13 are preferably placed on upper surface 8A of board 8, i.e., on a single plane. While the transmission signal passes through amplifier 11, transmission line 12, and antenna terminal 13, the transmission signal does not pass through a via-conductor which electrically connects upper surface 8A to lower surface 8B of board 8, hence being prevented from having a transmission loss.

FIG. 1B is a top view of another transmitter 1001 in Embodiment 1. In FIG. 1B, components identical to those of transmitter 7 shown in FIG. 1A are denoted by the same reference numerals, and their description will be omitted. Transmitter 1001 further includes directional coupler 51 and detection circuit 52. Directional coupler 51 is formed in transmission line 12, and takes a part of the transmission signal output from amplifier 11. The taken part of the transmission signal is returned to transmission circuit 9C of electronic circuit 9 via detection circuit 52, thereby stabilizing the output level of the transmission signal.

FIG. 1C is a top view of further transmitter 1002 according to Embodiment 1. In FIG. 1C, components identical to those of transmitter 7 shown in FIG. 1A are denoted by the same reference numerals, and their description will be omitted. In transmitter 1002, antenna terminal 1013 is placed on lower surface 8B of board 8 different from surface 8A having amplifier 11 placed thereon. This arrangement prevents the transmission signal amplified by amplifier 11 from being coupled to antenna terminal 13 without passing through transmission line 12.

FIG. 1D is a top view of further transmitter 1003 according to Embodiment 1. In FIG. 1D, components identical to those of transmitter 7 shown in FIG. 1A are denoted by the same reference numerals, and their description will be omitted. In transmitter 1003, amplifier 11, transmission line 12, and antenna terminal 13 are arranged along side 8D of board 8. This arrangement allows transmission path 1012A including transmission line 12 to be straight between amplifier 11 and antenna terminal 13, thereby eliminating a discontinuous portion in transmission line 12. This arrangement prevents discontinuity of impedance of transmission path 1012A and reflection of the transmission signal at the discontinued portion in the transmission path, accordingly suppressing the lowering of the level or distortion of the transmission signal amplified by amplifier 11.

Amplifier 11 outputs the transmission signal having a large amplitude. As shown in FIGS. 1A to 1D, amplifier 11 and oscillator 15 are preferably placed at corners 8F and 8G of rectangular board 8 opposite to each other, respectively. This arrangement provides a distance between amplifier 11 and oscillator 15 which is sufficient for suppressing mutual electromagnetic coupling and interference.

FIG. 1E is a schematic view of communication device 1008, such as a personal computer and mobile phone, according to Embodiment 1. Communication device 1008 includes transmitter 7 (1001, 1002, 1003) according to Embodiment 1, controller 1008A connected to bus 16 for controlling transmitter 7, and antenna 101 connected to antenna terminal 13. This communication device 1008 is used for wireless communication, such as LAN communication.

### Exemplary Embodiment 2

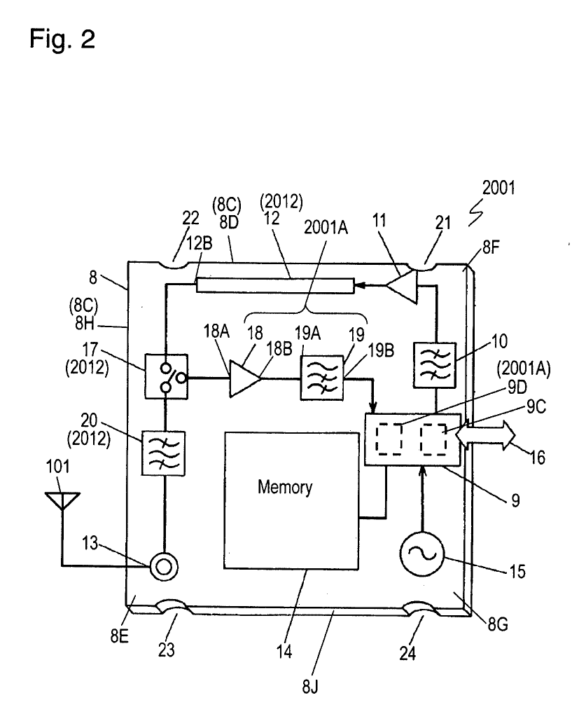

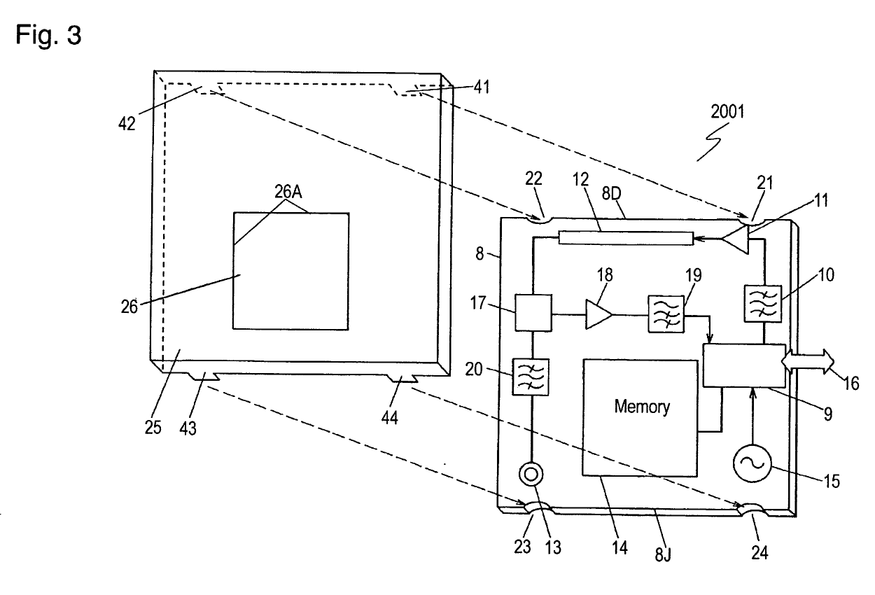

FIGS. 2 and 3 are a top view and an exploded perspective view of transmitter 2001 according to Exemplary Embodiment 2, respectively. In FIGS. 2 and 3, components identical to those of transmitter 7 shown in FIG. 1A are denoted by the same reference numerals, and their description will be omitted.

Transmitter 2001 according to Embodiment 2 includes receiver 2001A for receiving a radio wave received by antenna 101 via antenna terminal 13 in the transmitter shown in FIG. 1 according to Embodiment 1. Receiver 2001A includes low-noise amplifier 18, filter 19, and receiving circuit 9D included in electronic circuit 9. Low-noise amplifier 18 has input port 18A which is an input port of receiver 2001A. Switch 17 is connected between antenna terminal 13 and output port 12B of transmission line 12 for connecting antenna terminal 13 selectively to output port 12B of transmission line 12 and input port 18A of low-noise amplifier 18 by high-frequency AC coupling. Input port 19A of filter 19 is connected to output port 18B of low-noise amplifier 18 by high-frequency AC coupling. Output port 19B of output port 19 of filter 19 is connected to receiving circuit 9D in electronic circuit 9 by high-frequency AC coupling. Filter 20 is connected between switch 17 and antenna terminal 13. Transmission line 12, switch 17, and filter 20 provide transmission path 2012 which transmits a transmission signal output from amplifier 11 to antenna terminal 13. Switch 17 and filter 20 are arranged along side 8H of board 8. In other words, transmission path 2012 has a shape formed along sides 8D and 8H of border 8C of rectangular board 8, and is arranged along sides 8D and 8H of border 8C.

Filter 20 is a planar filter made of dielectric material. This filter 20 passes signals in a predetermined frequency band out of signals supplied from antenna terminal 13. Filter 20 may be made of magnetic material.

Switch 17 is an IC formed by a compound semiconductor process. Switch 17 may be configured with a circuit including a PIN diode.

Low-noise amplifier 18 amplifies a faint signal received at antennal terminal 13. Low-noise amplifier 18 is an IC formed by a compound semiconductor process or a bipolar transistor process, and has a gain not less than 10 dB, a noise index not larger than 2 dB, and a third order intermodulation distortion (IIP3 in) not less than −5 dBm.

Filter 19 is a high-pass filter including chip components. Filter 19 selectively removes signals outside a predetermined frequency band, thereby allowing transmitter 2001 to operate simultaneously to other systems, such as a mobile phone.

Notches 21 and 22 are formed in side 8D on a side surface of board 8. Notches 23 and 24 are formed in side 8J. Notches 21, 22, 23, and 24 in board 8 are located near board corners 8F, 8K, 8E, and 8G, respectively, so as to mount shield case 25 for covering the upper surface of board 8. Conductors connected to a ground of transmitter 2001 are provided on notches 21, 22, 23, and 24. Notch 21 is located near amplifier 11, and thereby, functions as a thermal via of amplifier 11 for releasing heat generated by amplifier 11, thus improving a heat-dissipating effect of transmitter 2001.

Shield case 25 has claws 41 to 44. Claws 41 to 44 are attached to notches 21 to 24 formed in on board 8, respectively, thereby fixing shield case 25 to board 8 and connecting shield case 25 to a ground of transmitter 2001. Opening 26 is provided in shield case 25. Opening 26 prevents components mounted on board 8 from contacting shield case 25. According to Embodiment 2, opening 26 has a rectangle shape, and is positioned above memory 14. A dimension, side 26A, of rectangular opening 26 is not longer than the wavelength of the transmission signal sent from antenna terminal 13 and the signal received at antenna terminal 13. This structure prevents the transmission signal and the received signal from directly affecting electronic components in shield case 25.

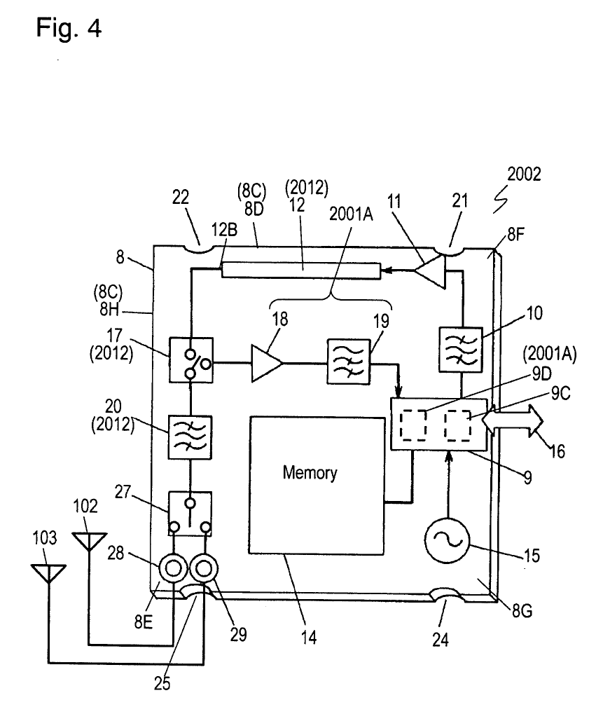

FIG. 4 is a top view of another transmitter 2002 according to Embodiment 2. In FIG. 4, components identical to those of transmitter 2001 shown in FIG. 2 are denoted by the same reference numerals, and their description will be omitted. Transmitter 2002 includes switch 27 and antenna terminals 28 and 29 instead of antenna terminal 13 of transmitter 2001. Switch 27 is connected to filter 20. Antenna terminals 28 and 29 are connected to switch 27. Switch 27 and antenna terminals 28 and 29 are placed on board 8. Antennas 102 and 103 are arranged to be connected to antenna terminals 28 and 29, respectively. Antennas 102 and 103 have directivities different from each other. Switch 27 connects filter 20 selectively to antennas 102 and 103, thereby providing receiver 2001A with diversity receiving. This diversity function can be activated during transmission.

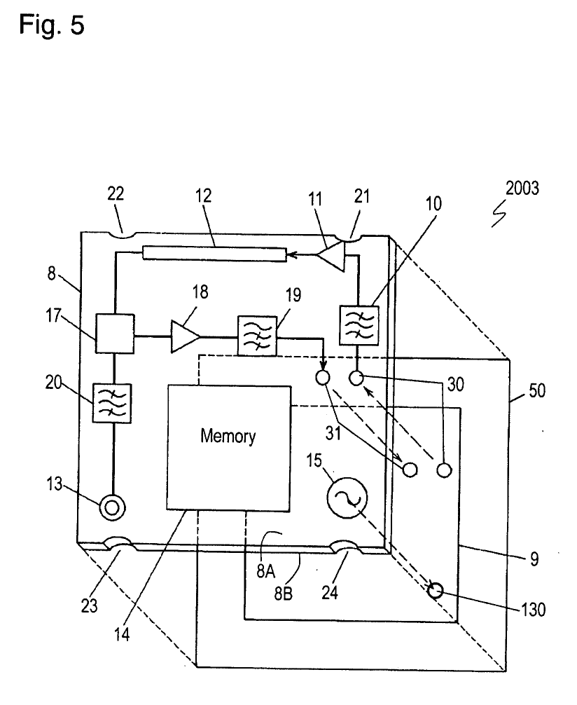

FIG. 5 is a top view of further transmitter 2003 according to Embodiment 2. In FIG. 5, components identical to those of transmitter 2001 shown in FIG. 2 are denoted by the same reference numerals, and their description will be omitted. In transmitter 2003, electronic circuit 9 is placed on lower surface 8B of board 8, not on upper surface 8A. The transmission signal generated by electronic circuit 9 is supplied to input port 10A of filter 10 via through-hole 30 which connects between upper surface 8A and lower surface 8B of board 8 by direct-current (DC) coupling. The received signal supplied from output port 19B of filter 19 is supplied to electronic circuit 9 via through-hole 31 connecting between upper surface 8A and lower surface 8B of board 8 by DC coupling. This arrangement prevents a digital noise generated by electronic circuit 9 from entering into amplifier 11, accordingly reducing deterioration of distortion characteristics of the transmission signal.

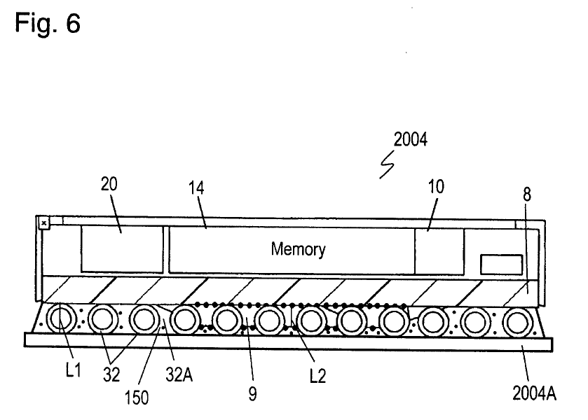

FIG. 6 is a sectional view of further transmitter 2004 according to Embodiment 2. In FIG. 6, components identical to those of transmitter 2003 shown in FIG. 5 are denoted by the same reference numerals, and their description will be omitted. In transmitter 2004, plural connection terminals 32 which have spherical shapes and are made of conductive material, such as solder, are placed on lower surface 8B of board 8. Connection terminals 32 are arranged along border 8C of board 8. The diameters, heights L1, of connection terminals 32 having the spherical shapes are longer than height L2 of electronic circuit 9. This size allows connecting terminals 32 to provide electrical connection and to function as posts supporting electronic circuit 9. Due to this structure, underfill agent 150 can be injected between transmitter 7 and motherboard 2004A through space 32A between connection terminals 32 after connection terminals 32 of transmitter 7 are mounted onto motherboard 2004A. This improves the strength of transmitter 7 against drop impact.

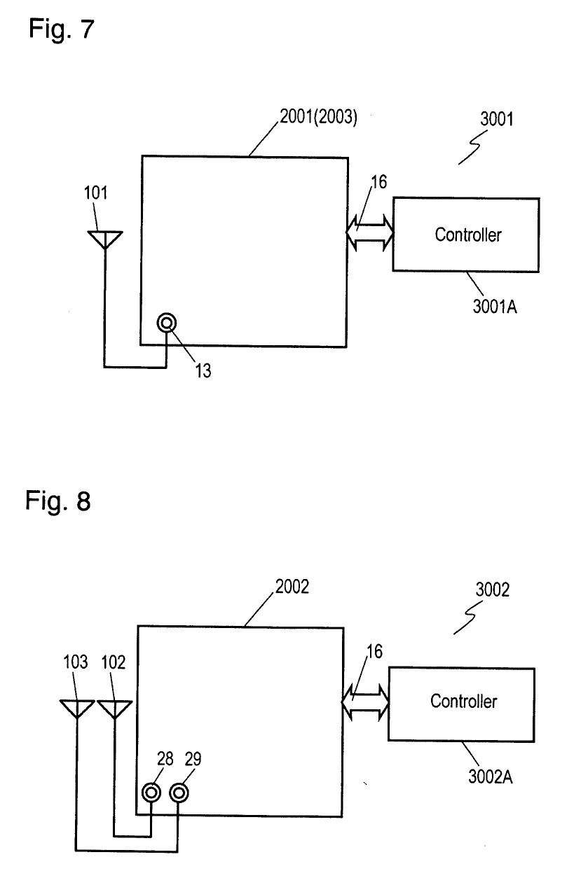

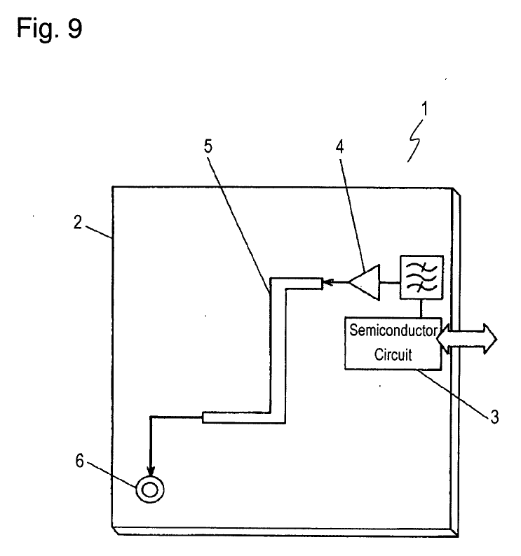

FIG. 7 is a schematic view of communication device 3001, such as a personal computer and mobile phone, according to Embodiment 2. Communication device 3001 includes transmitter 2001 (2003) according to Embodiment 2, controller 3001A connected to bus 16 for controlling transmitter 2001, and antenna 101 connected to antenna terminal 13. Communication device 3001 is used for wireless communications, such as LAN communications.

FIG. 8 is a schematic view of another communication device 3002, such as a personal computer and mobile phone, according to Embodiment 2. Communication device 3002 includes transmitter 2002 according to Embodiment 2, controller 3002A connected to bus 16 for controlling transmitter 2002, and antennas 102 and 103 connected to antenna terminals 28 and 29, respectively. Communication device 3002 is used for wireless communications, such as LAN communications.

Board 8 according to Embodiments 1 and 2 has a rectangular shape, however, may have another shape, such as triangular and circular shapes, providing the same effects.

### INDUSTRIAL APPLICABILITY

A transmitter prevents a transmitting signal from entering into other circuits, and thus, has preferable transmission characteristics, thus being useful for communication devices, such as a mobile terminal.

1. A transmitter comprising:
a board having a border;
an electronic circuit provided on the board, for outputting a transmission signal;
an amplifier provided on the board, for amplifying the transmission signal;
an antenna terminal provided on the board, the antenna terminal being arranged to be connected to an antenna; and
a transmission path arranged along the border of the board, the transmission path being connected to an output port of the amplifier and the antenna terminal, the transmission path supplying the amplified transmission signal to the antenna terminal.

2. The transmitter of claim 1, wherein the transmission path includes a transmission line having a shape formed along at least a portion of the border of the board, the transmission line being arranged along the at least the portion of the border of the board.

3. The transmitter of claim 2, wherein
the board has a first surface and a second surface opposite to the first surface, and
the amplifier, the transmission line, and the antenna terminal are provided on the first surface of the board.

4. The transmitter of claim 2, wherein
the board is a rectangular shape having sides, and
the amplifier, the transmission line, and the antenna terminal are arranged along one of the sides of the board.

5. The transmitter of claim 1, wherein
the board has a rectangular shape having four corners including two corners diagonal to each other, and
the antenna terminal and the amplifier are placed at the two corners, respectively.

6. The transmitter of claim 1, wherein
the board has a first surface and a second surface opposite to the first surface,
the amplifier is provided on the first surface of the board, and
the antenna terminal is provided on the second surface of the board.

7. The transmitter of claim 1, further comprising an oscillator disposed on the board, the oscillator supplying an oscillation signal to the electronic circuit, wherein
the board has a rectangular shape having four corners, and
the amplifier and the oscillator are provided at two corners out of the four corners of the board, respectively.

8. The transmitter of claim 1, further comprising a shield case covering a surface of the board, the shield case having an opening formed therein, the opening having a dimension not longer than a wavelength of the transmission signal.

9. The transmitter of claim 1, wherein
the board has a first surface and a second surface opposite to the first surface,
the amplifier is provided on the first surface of the board, and
the electronic circuit is provided on the second surface of the board.

10. The transmitter of claim 1, further comprising a connection terminal provided on a surface of the board, wherein
the electronic circuit is provided on the surface of the board, and
the connecting terminal has a height larger than a height of the electronic circuit.

11. The transmitter of claim 10, wherein the connection terminal has a spherical shape.

12. The transmitter of claim 1, further comprising a receiver provided on the board, for receiving a signal.

13. A communication device comprising:
a transmitter of any one of claims 1 to 12; and
a controller for controlling the transmitter.
